(19) United States
(12) Patent Application Publication
(10) Pub. No.: US 2026/0194718 A1
(43) Pub. Date: Jul. 9, 2026

(54) MULTI-CORE FIBER (MCF) GAIN FLATTENING FILTER (GFF) DEVICES

(71) Applicant: II-VI PHOTONICS, INC., Fuzhou (CN)

(72) Inventors: Dong Lin, Fuzhou (CN); Tingyu Xue, Fuzhou (CN); Cart Song, Fuzhou (CN); Baozhong Zheng, Fuzhou (CN); Yang Li, Fuzhou (CN); Zongyuan Wang, Fuzhou (CN); Leo Xu, Fuzhou (CN)

(21) Appl. No.: 19/015,303

(22) Filed: Jan. 9, 2025

(30) Foreign Application Priority Data
Jan. 8, 2025 (CN) 2025100310133

(51) Int. Cl. G02B 6/293; G02B 6/26; G02B 6/32

(52) U.S. Cl. CPC G02B 6/29391; G02B 6/262; G02B 6/264; G02B 6/32

(57) ABSTRACT

An optical device may have an input multiple-core fiber (MCF) collimator that includes a plurality of input fiber cores, an output multiple-core fiber (MCF) collimator that includes a plurality of output fiber cores, a first gain flattening filter (GFF), and a second gain flattening filter (GFF). The input MCF collimator and the output MCF collimator may be configured to communicate a plurality of collimated optical beams within the optical device. Each of the plurality of collimated optical beams is associated with one of the plurality of input fiber cores and a corresponding one of the plurality of output fiber cores. The first GFF and second GFF may be configured to apply gain flattening filtering to the plurality of collimated optical beams. One or both of the first GFF and the second GFF are configured and/or arranged to eliminate or mitigate channel cross-talk among the plurality of collimated optical beams.

### CLAIM OF PRIORITY

This patent application claims priority to and claims benefit from Chinese (CN) patent application No. 2025100310133, filed on Jan. 8, 2025. The above identified application is hereby incorporated herein by reference in its entirety.

### TECHNICAL FIELD

Aspects of the present disclosure relate to fiber-optic communication related solutions. More specifically, certain implementations of the present disclosure relate to methods and systems for implementing and utilizing improved multi-core fiber (MCF) gain flattening filter (GFF) devices, such as 4-core MCF GFF devices.

### BACKGROUND

Limitations and disadvantages of conventional and traditional devices and solutions for transmitting and receiving optical signals will become apparent to one of skill in the art, through comparison of such systems with some aspects of the present disclosure as set forth in the remainder of the present application with reference to the drawings.

### BRIEF SUMMARY

System and methods are provided for improved multi-core fiber (MCF) gain flattening filter (GFF) devices, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates a simplified schematic of an example optical device that provides gain flattening filtering.

FIG. 2A illustrates an example optical device that provides gain flattening filtering.

FIG. 2B illustrates an example gain flattening filter (GFF) and operation thereof when used in an optical device.

FIG. 2C illustrates paths of optical signals in an optical device incorporating 4-core multi-core fiber (MCF) and a gain flattening filter (GFF).

FIG. 3A illustrates an example optical device that may use multiple gain flattening filters (GFFs).

FIG. 3B illustrates paths of optical signals in an optical device incorporating 4-core multi-core fiber (MCF) and two gain flattening filters (GFFs).

FIG. 4 illustrates an example 4-core multi-core fiber (MCF).

FIG. 5 is a graph illustrating transmittance curves for gain flattening filtering functions.

### DETAILED DESCRIPTION

The present disclosure is directed to fiber-optic communication related solutions. In particular, embodiments based on the present disclosure pertain to optical devices that may be used in fiber-optic communication, with these optical devices having improved performance, particularly with respect to the gain flattening filtering functions performed therein. In this regard, various types of fibers may be used in fiber-optic communication networks. One common type of fiber is single-mode fiber (SMF), which is an optical fiber comprising a single core configured to carry (propagate) a single light beam, typically of a single mode of light (e.g., transverse mode). In some instances, however, it may be desirable to use multiple-core fiber. In this regard, in some fiber-optic communication networks, other types of fiber allowing for multiple concurrent optical transmissions may be used. For example, multi-core fiber (MCF) may be used. The MCF comprises multiple cores, with each core typically configured to carry (propagate) a single light beam. Use of MCFs may allow for increasing capacity in the network. Use of such multiple-core fibers (MCFs) may be desirable as it may allow for increasing capacity, reducing the physical size of a fiber bundle, and/or reducing the number of individual components in a link. In this regard, in some instances, the MCF may be the same size as SMF, and as such the multiple cores of MCF may be arranged within the same space/size used in SMF. As such, use of MCF may allow for multiplication of transmission capacity without increasing space requirements.

In some instances, there may be a need to connect fibers in the network. This may include connections between different fibers (e.g., between SMF and MCF cables, between MCFs having different cores/channels, etc.), or between fibers that are similar (e.g., MCF with same number/layout of cores/channels). To facilitate such connections, suitable systems or devices are used that allow for connecting the fibers. For example, suitable optical devices may be used in connecting fibers, with each such optical device being configured to receive a fiber as an input on one end, and engage a fiber as an output on the other end. The optical signal(s) carried in the input fiber may propagate via the optical device into corresponding cores/channels in the output fiber.

In some instances, such optical devices may be configured to provide or use one or more signal processing related functions to facilitate or otherwise enable the forwarding of optical signal(s) from the input fiber(s) to the output fiber(s). One such signal processing related function is gain flattening filtering. In this regard, gain flattening filtering may be used to flatten or smooth out unequal signal intensities over a specified wavelength range. Such unequal signal intensities may occur with the optical device, such as after an amplification stage. As such, connecting optical devices may utilize gain flattening filters (GFFs) in conjunction with gain amplifiers to ensure that the amplified channels all have the same gain.

However, conventional designs of connecting optical devices may have some limitations and/or shortcomings. In particular, gain flattening filters (GFFs) used in various optical device may introduce some performance related issues, such as channel cross-talk interferences, which may affect the quality of optical signals in one or more channels.

In this regard, an example GFF based optical device may comprise a pair of collimators (one for each of the input-side output-side) and one GFF with a specifically designed transmittance spectrum. The input-output collimators are used for conversion between an in-fiber optical signal and a free-space optical signal. The GFF may have a specifically designed transmittance spectrum, and may be used in-between input-output collimators for optical signal flattening—e.g., to flatten the spectrum curve of input optical signal(s) for the purpose of optical communication link signal gain equalization. In instances, where the GFF based optical device may be a multi-channel device (e.g., a 4-channel GFF device), multi-core fibers (e.g., 4-core fibers) are used at each of the input-side output-side fiber ends. During handling within a multi-channel device, the incident angles of all channels may be adjusted equally to realize a desired transmission spectrum—that is, spectrum shifts when an incident angle changes resulting in inherent cross-talk.

Solutions based on the present disclosure address limitations and/or shortcomings of conventional designs, particularly by use of a modified approach for providing gain flattening filtering, to reduce or mitigate some of the issues associated with gain flattening filtering in conventional designs, such as channel cross-talk related issues.

Example embodiments in accordance with the present disclosure are described in more detail below, particularly with respect to the figures.

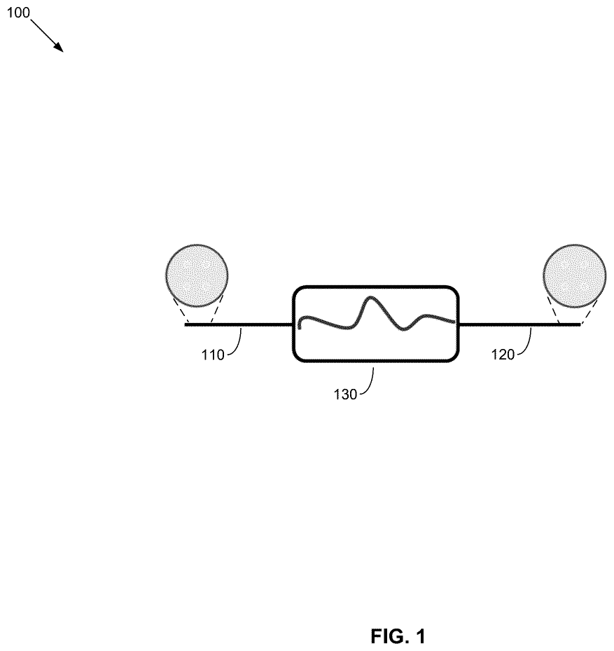

FIG. 1 illustrates a simplified schematic of an example optical device that provides gain flattening filtering. Shown in FIG. 1 is optical device 100 (or a simplified schematic representation of at least a portion thereof).

The optical device 100 comprises suitable hardware and related circuitry for handling optical signals, which may be conveyed via optical fiber, and for providing one or more processing functions relating to the optical signals and handling thereof, including gain flattening filtering. The optical device 100 may be configured for handling multi-core fiber (MCF). In this regard, the optical device 100 comprises an input multi-core fiber (MCF) 110, an output multi-core fiber (MCF) 120, and gain flattening filter (GFF) 130.

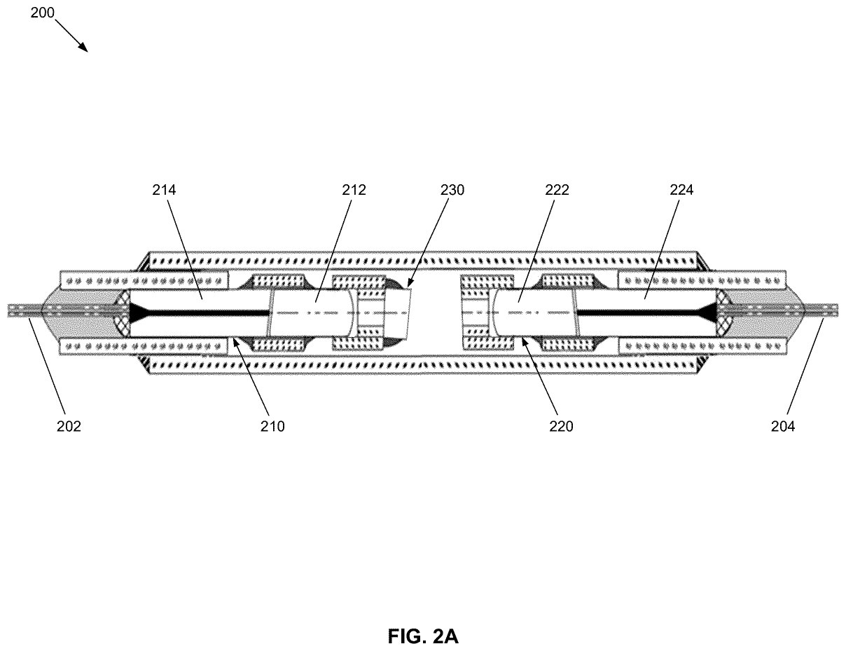

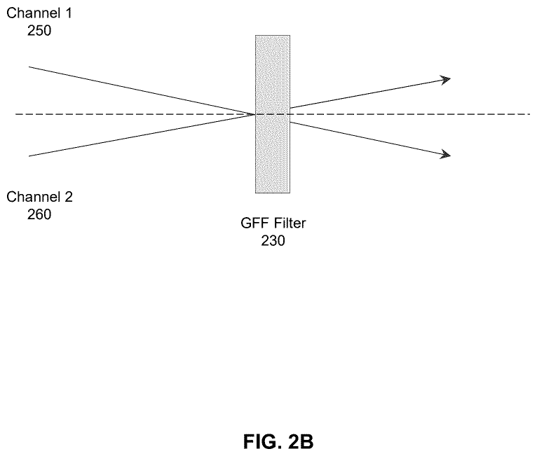

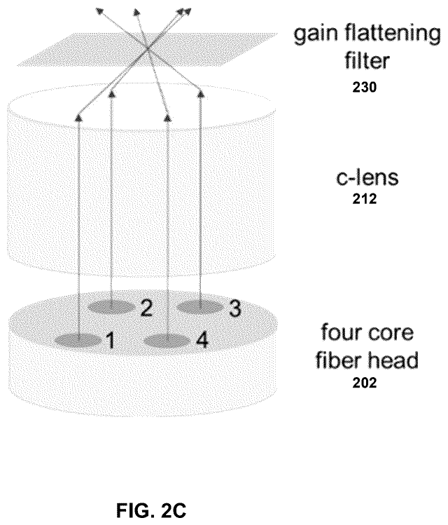

For example, as shown in FIG. 1, the optical device 100 may be a 4-core (4 channels) based device, and as such each of the input MCF 110 and the output MCF 120 may be 4-core MCF. The input MCF 110 and the output MCF 120 may be terminated within the optical device 100 using suitable hardware components, such as collimators—that is, with the input MCF 110 and the output MCF 120 being engaged by, respectively, input MCF collimator and output MCF collimator. This is illustrated in FIG. 2A.

The GFF 130 may be configured to provide gain flattening filtering to the optical signals as these signals pass within the optical device 100, between the input MCF 110 and the output MCF 120. In this regard, as noted above, gain flattening filtering may be used to flatten or smooth out unequal signal intensities over a specified wavelength range. The GFF 130 may have a specifically designed transmittance spectrum, and may be used to flatten the spectrum curve of input optical signal(s) of the input MCF 110, such as to ensure optical communication link signal gain equalization.

Because the fibers (the input MCF 110 and output MCF 120) are multi-core fibers (e.g., 4-core fibers), the incident angles of all 4 channels may be adjusted equally, to realize a desired transmission spectrum—that is, spectrum shifts when incident angle change. This may result in channel cross-talk, which may affect performance. This is illustrated and described in more detail with respect to FIGS. 2A-2C.

FIG. 2A illustrates an example optical device that provides gain flattening filtering. Shown in FIG. 2A is an optical device 200.

The optical device 200 comprises an input multi-core fiber (MCF) collimator 210, an output multi-core fiber (MCF) collimator 220, and gain flattening filter (GFF) 230. The input MCF collimator 210 and the output MCF collimator 220 engage, respectively, an input fiber 202 and an output fiber 204.

The input MCF collimator 210 comprises a glass capillary 214, and a lens (e.g., C-lens) 212. Similarly, the output MCF collimator 220 comprises a lens (e.g., C-lens) 222, and a glass capillary 224. In this regard, the input fiber 202 is disposed within the glass capillary 214 and terminates at the lens 212. Similarly, the output fiber 204 is disposed within the glass capillary 224 and terminates at the lens 222.

As shown in FIG. 2A, each of the input fiber 202 and an output fiber 204 comprises a 4-core multi-core fiber (MCF), and correspondingly, each of the input MCF collimator 210 and the output MCF collimator 220 comprises a 4-core MCF collimator.

The gain flattening filter (GFF) 230 is disposed at the interior end of the input MCF collimator 210—that is, adjacent to (e.g., on the surface of) the lens 212, facing the lens 222 of the output MCF collimator 220, as shown.

In operation, the optical device 200 may be used in routing optical signal(s), particularly by communicating via the output fiber 204 optical signals received via the input fiber 202. The GFF 230 may be used to apply gain flattening filtering to the optical signals between the input MCF collimator 210 and the output MCF collimator 220. In this regard, the GFF 230 may have a specifically designed transmittance spectrum. However, the spectrum may shift when incident angle(s) change. For example, since the optical device 200 is a 4-channel device, to ensure the consistency of transmittance spectrum of the 4 channels, the incident angle of the optical beam of every channel should be set equally. Since the angles of each two opposing channel beams satisfy the law of reflection, an inherent, and possibly large, cross-talk interference may be introduced between two opposing channels (e.g., channels 1 and 3, or channels 2 and 4), as well as between the other two opposing channels. This is illustrated in FIGS. 2B-2C.

FIG. 2B illustrates an example gain flattening filter (GFF) and operation thereof when used in an optical device. Shown in FIG. 2B is the GFF 230 of the optical device 200.

As shown in FIG. 2B, where a single GFF is used (e.g., the GFF 230 in the optical device 200), applying gain flattening filtering via the GFF typically entails applying or otherwise using equal incident angle(s), to meet the requirements of a target GFF transmission curve—that is, each channel is applied to the GFF at the same angle, as shown with channel 1 and channel 2 in FIG. 2B. Consequently, the channels on the input-side may line up with other channels on the output-side, which result in inherent channel cross-talk caused by the equal incident angle(s). This is illustrated more clearly in FIG. 2C.

FIG. 2C illustrates paths of optical signals in an optical device incorporating 4-core multi-core fiber (MCF) and a gain flattening filter (GFF). Shown in FIG. 2C are the paths of optical signals in the optical device 200 during an example use scenario.

In this regard, shown in FIG. 2C are the paths of the 4 optical signals in the 4 channels of the optical device 200 as they traverse from the channels of the input fiber 202, through the lens 212 of the input MCF collimator 210, then through the GFF 230. As noted, equal incident angles may be used according to the requirements of a target GFF transmission curve. In particular, as optical signals pass from the cores/channels of the input MCF 202, the signals are subjected to refraction(s) via the lens 212 of the input MCF collimator 210, as shown in FIG. 2C. The signals are then subjected to corresponding, correcting refraction(s) via the lens 222 of the output MCF collimator 220, to re-align them with the cores/channels of the output MCF 204 (not shown).

As noted, the equal incident angles may cause channel cross-talk while the signals are subjected to gain flattening filtering via the GFF 230, as portion(s) of the refraction may pass between channels (e.g., from channel 1 at the input-side to channel 3 at the output-side, from channel 2 at the input-side to channel 4 at the output-side, from channel 3 at the input-side to channel 1 at the output-side, and from channel 4 at the input-side to channel 2 at the output-side).

Solutions based on the present disclosure may be configured to address issues associated with gain flattening filtering in conventional designs, such as channel cross-talk related issues. In this regard, in various embodiments based on the present disclosure, gain flattening filtering optical devices may be configured to reduce or mitigate channel cross-talk when providing gain flattening filtering in conventional designs. This may be done, for example, by utilizing modified designs to facilitate applying gain flattening filtering in a manner where no (or minimal) channel cross-talk occurs. In some example embodiments this may be done by configuring the components used in applying the gain flattening filtering to prevent or otherwise mitigate the effects of incident angles.

For example, whereas in many conventional designs a single GFF is used (e.g., similar to the optical device 200), a plurality of GFFs may be used instead, to allow for mitigating the effects of incident angle(s) that may result in channel cross-talk. In various example embodiments, a pair of GFFs may be used, for example. In this regard, in order to solve the inherent, possibly large, cross-talk problem induced by an equal incident angle of multiple input signals relative to a single gain flattening filter, two filters with a specifically designed transmittance spectrum may be used instead. The two filters may be arranged in a manner that allows for providing the gain flattening filtering in the course of passing optical signals between the input and output channels, while reducing or even eliminating channel cross-talk. An example optical device incorporating such design is shown and described in more detail below.

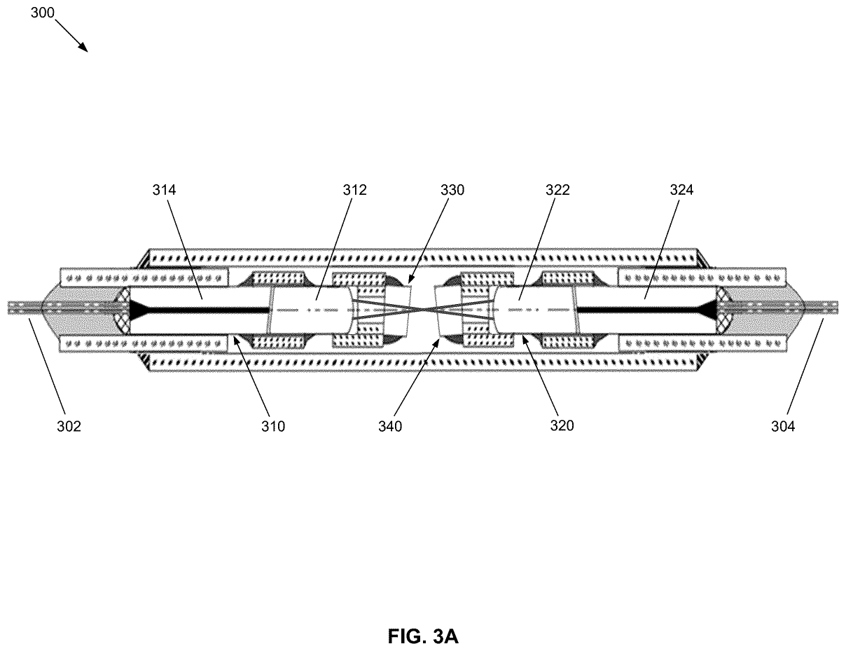

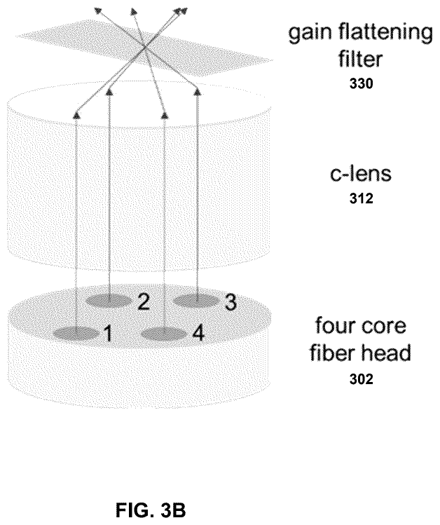

FIG. 3A illustrates an example optical device that may use multiple gain flattening filters (GFFs). Shown in FIG. 3A is an optical device 300.

The optical device 300 is substantially similar to the optical device 200, and may operate in substantially similar manner. However, the optical device 300 may be modified for improved performance, particularly with respect to the gain flattening filtering performed therein. This may be done by incorporating multiple gain flattening filters (GFFs). For example, the optical device 200 may incorporate two GFFs arranged and/or otherwise configured to operate concurrently to improve performance.

In this regard, as shown in FIG. 3A, the optical device 300 comprises an input multi-core fiber (MCF) collimator 310, an output multi-core fiber (MCF) collimator 320, a first gain flattening filter (GFF) 330 and a second gain flattening filter (GFF) 340. The input MCF collimator 310 and the output MCF collimator 320 engage, respectively, an input fiber 302 and an output fiber 304.

The input MCF collimator 310 may be substantially similar to the input MCF collimator 210, and as such similarly may comprise a glass capillary 314, and a lens (e.g., C-lens) 312. Similarly, the output MCF collimator 320 may be substantially similar to the output MCF collimator 220, and as such similarly may comprise a lens (e.g., C-lens) 322, and a glass capillary 324. Further, the input fiber 302 is similarly disposed within the glass capillary 314 and terminates at the lens 312, whereas the output fiber 304 is similarly disposed within the glass capillary 324 and terminates at the lens 322.

As with the optical device 200, the optical device 300 may be a 4-core based implementation, and as such each of the input fiber 302 and an output fiber 304 comprises a 4-core multi-core fiber (MCF), and correspondingly, each of the input MCF collimator 310 and the output MCF collimator 320 comprises a 4-core MCF collimator.

The first GFF 330 may be substantially similar to the GFF 230, and similarly may be disposed at the interior end of the input MCF collimator 310—that is, adjacent to (e.g., on the surface of) the lens 312, facing the lens 322 of the output MCF collimator 320, as shown. The second GFF 340 also may be substantially similar to the GFF 230. However, the second GFF 340 is disposed at the interior end of the output MCF collimator 320—that is, adjacent to (e.g., on the surface of) the lens 322, facing the lens 312 of the input MCF collimator 310, as shown.

In operation, the optical device 300 may operate substantially in a similar manner as the optical device 200—that is, by routing optical signal(s) from the input fiber 302 into the output fiber 304 optical signals, and applying gain flattening filtering to the optical signals between the input MCF collimator 310 and the output MCF collimator 320. In this regard, the first GFF 330 and the second GFF 340 may be configured to apply, collectively, gain flattening filtering to the optical signals. The aggregate gain flattening filtering applied by the first GFF 330 and the second GFF 340 may be equivalent to the gain flattening filtering applied by the GFF 230.

However, the first GFF 330 and the second GFF 340 may be configured and/or arranged in a manner that allows for solving the inherent, possibly large, cross-talk problem induced by equal incident angles of multiple input signals relative to a single gain flattening filter as described above. In this regard, the two filters may be configured and/or arranged to provide a specifically designed transmittance spectrum for improved performance—e.g., a same gain flattening filtering as provided in conventional design but without the channel cross-talk. The filters may be arranged in manner that optimize performance.

For example, the two filters may be intentionally tilted at a particular angle to avoid cross-talk between multiple channels, and this angle for two specifically designed filters are equal in absolute value, but opposite in sign (e.g., 2.5° and)−2.5°. In other words, the GFFs may be tilted by the same angle but in opposite directions, as shown in FIG. 3A. The effects of using tilted-based design are illustrated in FIG. 3B. The tilt angles may be set or selected adaptively, to optimize performance—e.g., just to ensure eliminating or at least reducing channel cross-talk. The tilt angles may be within a pre-determined optimal range, such as 0.5-15° (but more often it is) 2-3°.

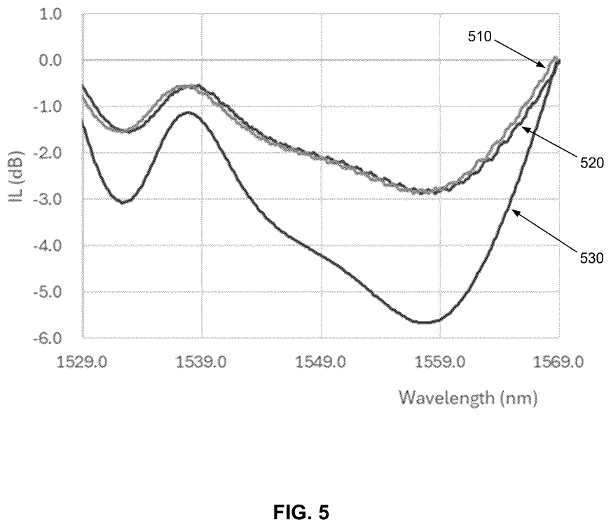

In an example use scenario in an optical device using such design (e.g., the optical device), an input signal may shift left (or right) when passing through the first filter and shift right (or left) back when passing through the second filter. The transmission curves of these two filters may be tailored to be half of the value of a traditional design, and fine trimmed to make sure that a target transmission curve (e.g., similar to the one corresponding to a single filter in corresponding conventional design) may be obtained by superposition of minor half left shift and half right shift. Example transmittance performance of such filters is shown and described with respect to FIG. 5.

FIG. 3B illustrates paths of optical signals in an optical device incorporating 4-core multi-core fiber (MCF) and two gain flattening filters (GFFs). Shown in FIG. 3B are the paths of optical signals in the optical device 300 during an example use scenario.

In particular, shown in FIG. 3B are the paths of the 4 optical signals in the 4 channels of the optical device 300 as they traverse from the channels of the input fiber 302, through the lens 312 of the input MCF collimator 310, then through the first GFF 330. In this regard, because the optical device 300 incorporates a pair of tilted GFFs (rather than single GFF as it is the case in the optical device 200), the input and channels do not line up in the same manner as it is the case with the single GFF based design, preventing the creation of condition that may result in channel cross-talk, as illustrated in FIG. 3B.

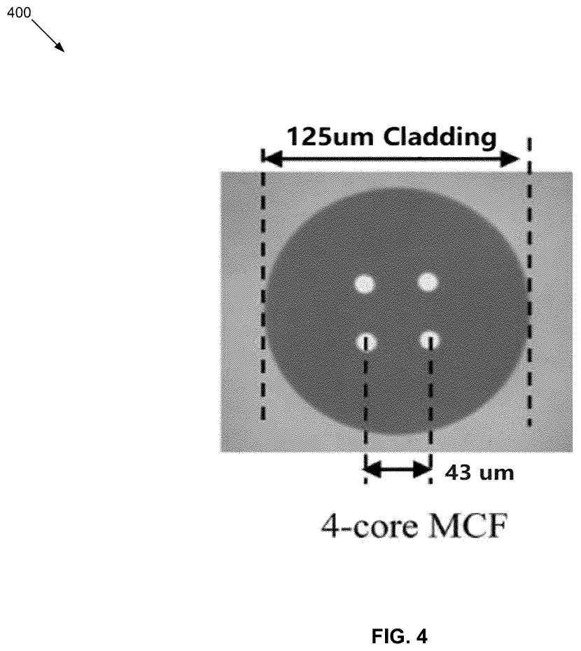

FIG. 4 illustrates an example 4-core multi-core fiber (MCF). Shown in FIG. 4 is an example 4-core multi-core fiber (MCF) 400 that may be used in implementations based on the present disclosure.

The 4-core MCF 400 may correspond to, and/or may be used for one or both of the input fiber 302 and the output fiber 304 in the output device 300 (and similarly one or both of the input fiber 202 and the output fiber 204 in the output device 200), each of which are shown and/or described as 4-core MCF. As illustrated in FIG. 4, the 4-core MCF 400 comprises four (4) individual-core fibers within a cladding having a diameter of 125 microns (μm), with and core spacing of 43 microns (μm), as shown.

Table 1 below includes more detailed specifications of the 4-core MCF 400. Nonetheless, it should be understood that the 4-core MCF 400 and the specifications and/or characteristics thereof as disclosed herein only represent an example implementation, and that the disclose is not limited to use of MCFs similar to the 4-core MCF 400.

TABLE 1
specifications of the 4-core MCF 400

| parameter | value | unit |
|---|---|---|
| Number of cores | 4 | n/a |
| Core spacing | 43 ± 0.35 | μm |
| Cladding diameter | 124.7 ± 0.7 | μm |
| Coating diameter | 250 ± 5 | μm |
| Numerical aperture | 0.12 | n/a |
| Cutoff wavelength | <1520 | μm |
| Mode field diameter (@ 1550 μm) | 10.5 ± 0.5 | μm |
| PMD (@ 1550 μm) | <0.2 | ps/km½ |

FIG. 5 is a graph illustrating transmittance curves for gain flattening filtering functions. Shown in FIG. 5 is a graph 500 illustrating transmittance curves for gain flattening filters (GFFs) and corresponding gain flattening filtering provided thereby.

The graph 500 comprises data representing transmittance characteristics of gain flattening filters (GFFs). In this regard, the graph 500 comprises a plurality of plots 510, 520, and 530, with each of the plots comprising data points representing intensity level (IL) in decibels (dB) (y-axis) as a function of wavelength of the optical signal(s) being filtered in nanometer (nm) (x-axis).

In particular, the graph 500 shows the transmittance curve(s) of two gain flattening filters (plots 510 and 520) and a superimposition transmittance curve (plot 530) of two gain flattening filters with tilt angle in opposite signs. For example, the filters may correspond to the first GFF 330 and the second GFF 340. The two filters have the same coating design, and as such these filter have the same transmission spectrum. One filter may be tilted at a particular angle to one side (plot 510), and the other filter may be tilted at the same angle to the other side (plot 520).

The plot 530 may represent a target curve, which may correspond to use of a single filter, such as in a conventional design based implementation (e.g., the GFF 230 in the optical device 200). As such, plots 510 and 520 may represent the transmittance curves of the two filters that may be used to provide, in the aggregate, the gain flattening filtering that may be provided by a single filter in corresponding conventional design (but the cross-talk that may be introduced in such conventional design).

Accordingly, the transmittance curve (e.g., plot 510) of one filter may be offset by a certain small wavelength towards the short wavelength direction from the curve of normal incidence, and the transmittance curve (e.g., plot 520) of the other filter may be offset by a certain small wavelength towards the long wavelength direction. Combining (superposing) of these two curves yields the target curve (plot 530), as shown in FIG. 5.

An example optical device, in accordance with the present disclosure, comprises an input multiple-core fiber (MCF) collimator comprising a plurality of input fiber cores; and an output multiple-core fiber (MCF) collimator comprising a plurality of output fiber cores; a first gain flattening filter (GFF); and a second gain flattening filter (GFF); where the input MCF collimator and the output MCF collimator are configured to communicate a plurality of collimated optical beams within the optical device; where each of the plurality of collimated optical beams is associated with one of the plurality of input fiber cores and a corresponding one of the plurality of output fiber cores; where the first gain flattening filter (GFF) and second gain flattening filter (GFF) are configured to apply gain flattening filtering to the plurality of collimated optical beams; and where one or both of the first gain flattening filter (GFF) and the second gain flattening filter (GFF) are configured and/or arranged to eliminate or mitigate channel cross-talk among the plurality of collimated optical beams.

In an example embodiment, at least one of the first gain flattening filter (GFF) and the second gain flattening filter (GFF) is tilted at particular tilt angle to eliminate or mitigate the channel cross-talk.

In an example embodiment, both of the first gain flattening filter (GFF) and the second gain flattening filter (GFF) are tilted at the tilt angle and in opposite directions.

In an example embodiment, the tilt angle is within range of 0.5 to 15 degrees.

In an example embodiment, the tilt angle is within range of 2 to 3 degrees.

In an example embodiment, the tilt angle is approximately 2.5 degrees.

In an example embodiment, the first gain flattening filter (GFF) is disposed adjacent to the input multiple-core fiber (MCF) collimator.

In an example embodiment, the input multiple-core fiber (MCF) collimator comprises a lens at an output end facing the output multiple-core fiber (MCF) collimator, and where the first gain flattening filter (GFF) abuts the output end.

In an example embodiment, the second gain flattening filter (GFF) is disposed adjacent to the output multiple-core fiber (MCF) collimator.

In an example embodiment, the output multiple-core fiber (MCF) collimator comprises a lens at an input end facing the input multiple-core fiber (MCF) collimator, and where the second gain flattening filter (GFF) abuts the input end.

In an example embodiment, each of the input MCF collimator and the output MCF collimator comprises a 4-core MCF collimator.

In an example embodiment, each of the plurality of input fiber cores and the plurality of output fiber cores comprises a same number of cores.

In an example embodiment, a number of beams of the plurality of collimated optical beams is same as the number of cores.

In an example embodiment, the first gain flattening filter (GFF) has a first transmittance curve, and a second gain flattening filter (GFF) has a second transmittance curve, and where an aggregate of the first transmittance curve and the second transmittance curve corresponds to a target transmittance curve for a total gain flattening filtering of the optical device.

In an example embodiment, the input multiple-core fiber (MCF) collimator engages an input multiple-core fiber (MCF).

In an example embodiment, the input multiple-core fiber (MCF) comprises a same number of cores as the plurality of input fiber cores.

In an example embodiment, the output multiple-core fiber (MCF) collimator engages an output multiple-core fiber (MCF).

In an example embodiment, the output multiple-core fiber (MCF) comprises a same number of cores as the plurality of output fiber cores.

In an example embodiment, each beam of the plurality of collimated beams is associated with a unique input fiber core from the plurality of input fiber cores and with a unique output fiber core of the plurality of output fiber cores.

In an example embodiment, the optical device further comprises a device body that defines an interior space where the device body engages the input MCF collimator at a first end and the output MCF collimator at a second end, and the input MCF collimator and the output MCF collimator are arranged and/or configured to communicate the plurality of collimated optical beams between the first end and the second end, within the interior space.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic component (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical implementation may comprise one or more application specific integrated circuit (ASIC), one or more field programmable gate array (FPGA), and/or one or more processor (e.g., x86, x64, ARM, PIC, and/or any other suitable processor architecture) and associated supporting circuitry (e.g., storage, DRAM, FLASH, bus interface circuits, etc.). Each discrete ASIC, FPGA, Processor, or other circuit may be referred to as “chip,” and multiple such circuits may be referred to as a “chipset.” Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to perform processes as described in this disclosure. Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to be configured (e.g., to load software and/or firmware into its circuits) to operate as a system described in this disclosure.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. An optical device comprising:
an input multiple-core fiber (MCF) collimator comprising a plurality of input fiber cores;
an output multiple-core fiber (MCF) collimator comprising a plurality of output fiber cores;
a first gain flattening filter; and
a second gain flattening filter;
wherein the input MCF collimator and the output MCF collimator are configured to communicate a plurality of collimated optical beams within the optical device;
wherein each of the plurality of collimated optical beams is associated with one of the plurality of input fiber cores and a corresponding one of the plurality of output fiber cores;
wherein the first gain flattening filter and second gain flattening filter are configured to apply gain flattening filtering to the plurality of collimated optical beams; and
wherein one or both of the first gain flattening filter and the second gain flattening filter are configured and/or arranged to eliminate or mitigate channel cross-talk among the plurality of collimated optical beams.

2. The optical device of claim 1, wherein at least one of the first gain flattening filter and the second gain flattening filter is tilted at a particular tilt angle to eliminate or mitigate the channel cross-talk.

3. The optical device of claim 2, wherein both of the first gain flattening filter and the second gain flattening filter are tilted at the tilt angle and in opposite directions.

4. The optical device of claim 2, wherein the tilt angle is within a range of 0.5 to 15 degrees.

5. The optical device of claim 2, wherein the tilt angle is within a range of 2 to 3 degrees.

6. The optical device of claim 2, wherein the tilt angle is approximately 2.5 degrees.

7. The optical device of claim 1, wherein the first gain flattening filter is disposed adjacent to the input MCF collimator.

8. The optical device of claim 7, wherein the input MCF collimator comprises a lens at an output end facing the output MCF collimator, and wherein the first gain flattening filter (GFF) abuts the output end.

9. The optical device of claim 1, wherein the second gain flattening filter is disposed adjacent to the output MCF collimator.

10. The optical device of claim 9, wherein the output MCF collimator comprises a lens at an input end facing the input MCF collimator, and wherein the second gain flattening filter abuts the input end.

11. The optical device of claim 1, wherein each of the input MCF collimator and the output MCF collimator comprises a 4-core MCF collimator.

12. The optical device of claim 1, wherein each of the plurality of input fiber cores and the plurality of output fiber cores comprises a same number of cores.

13. The optical device of claim 12, wherein a number of beams of the plurality of collimated optical beams is the same as the number of cores.

14. The optical device of claim 1, wherein the first gain flattening filter has a first transmittance curve, wherein the second gain flattening filter has a second transmittance curve, and wherein an aggregate of the first transmittance curve and the second transmittance curve corresponds to a target transmittance curve for a total gain flattening filtering of the optical device.

15. The optical device of claim 1, wherein the input MCF collimator engages an input multiple-core fiber.

16. The optical device of claim 15, wherein the input MCF comprises a same number of cores as the plurality of input fiber cores.

17. The optical device of claim 1, wherein the output MCF collimator engages an output multiple-core fiber.

18. The optical device of claim 17, wherein the output MCF comprises a same number of cores as the plurality of output fiber cores.

19. The optical device of claim 1, wherein each beam of the plurality of collimated beams is associated with a unique input fiber core from the plurality of input fiber cores and with a unique output fiber core of the plurality of output fiber cores.

20. The optical device of claim 1, further comprising a device body that defines an interior space; wherein:
the device body engages the input MCF collimator at a first end and the output MCF collimator at a second end; and
the input MCF collimator and the output MCF collimator are arranged and/or configured to communicate the plurality of collimated optical beams between first end and the second end, within the interior space.
